(19) United States
(12) Patent Application Publication
(10) Pub. No.: US 2018/0365706 A1
(43) Pub. Date: Dec. 20, 2018

(54) ANTI-COUNTERFEITING SYSTEM AND A METHOD THEREOF

(71) Applicant: Ngo Tran, San Jose, CA (US)

(72) Inventor: Ngo Tran, San Jose, CA (US)

(73) Assignee: Bestsky American Inc, San Jose, CA (US)

(21) Appl. No.: 15/624,776

(22) Filed: Jun. 16, 2017

(51) Int. Cl. G06Q 30/00; G06K 19/07; G06K 7/10; H04W 4/02

(52) U.S. Cl. CPC G06Q 30/0185; H04W 4/02; G06K 7/10297; G06K 19/0723

(57) ABSTRACT

The present invention discloses an anti-counterfeiting system and a method thereof. The system includes an anti-counterfeiting chip further comprising a NFC module, a Jeptag module, a GPS module, and other modules; a reader or reading the chip; a GPS satellite; and a cloud server having memory storage. The chip is configured to store attributes of a commodity being tracked for counterfeiting and track the location of the counterfeit commodity from manufacturing until distribution.

### FIELD OF INVENTION

The present invention relates generally to an anti-counterfeiting system and a method thereof. More particularly, the present invention relates to tracking illegal counterfeit of commodities from manufacturing until distribution.

### BACKGROUND OF THE INVENTION

Imitation i.e. counterfeiting of goods is a longstanding problem, growing in scope and magnitude every year. It is one of the major concerns of Government because of various reasons such as its negative impact on innovation, threat posing to health and welfare of the consumers, opening path to crime which can further disrupt and corrupt the society. The counterfeiting may also affect brand value and company's reputation, thereby discouraging companies and inventors for new innovations.

In some instances, counterfeiting involves cloning which can be done by reverse engineering and by obtaining intellectual property illegally. In some instances, design houses outsource their designs for fabrication and packaging to companies all around the world, mainly to reduce the manufacturing cost. Overproduction occurs when foundries and packaging companies sell components outside of contract with the design house (component's intellectual property (IP) owner). In some other instances, the overproduced goods can include identical components and design of the valid goods. In some instances, defective products or parts therein are sold in the open markets, either knowingly or by an untrusted entity or third party. The defective products or parts produce an incorrect response to manufacturing tests, and such products or parts should be destroyed, downgraded or disposed of. In some instances, a reclaimed/recovered electronic component from a system being modified to be misrepresented as a new component of a proper manufacturer is also a counterfeit. Remarking of legitimate components to indicate another model or category is another example of counterfeit. In some instances, goods can be tampered to replace internal components. Medicines and drugs can be frequently imitated such as by re-labeling of expired or low-dose drugs, and so on.

Hence, the counterfeit products exist in almost every area, including food, beverages, clothes, shoes, pharmaceuticals, electronics, auto parts, toys, currency, and so on. The spread of counterfeit goods is worldwide, and in 2008 a study by the International Chamber of Commerce (ICC) estimated the global value of all counterfeit goods to reach $650 billion every year, doubling the estimated annual profit made from the sale of illegal drugs worldwide. The same study projected that in 2015 the upper bound of the global value of counterfeit and pirated goods can be $1.77 trillion. The counterfeit products make up 5 to 7% of world trade and cost an estimated 2.5 million jobs worldwide with 750,000 jobs lost in the U.S. alone. Millions of dollars are spent every year by companies fighting the sale of counterfeit goods.

A group of luxury brands including Gucci and Yves Saint Laurent sued the Chinese online shopping giant Alibaba Group Holding Ltd. for alleged violations of trademark and racketeering laws, asserting that they had knowingly made it possible for counterfeiters to sell their fake products internationally. In another lawsuit, a 45-year-old Chinese woman has been facing lawsuits against her for counterfeiting from eight luxury brands, including Gucci and Louis Vuitton, for over eight years. In 2008, a federal judge in California ordered Xu Ting to pay Chanel Inc. $6.9 million in damages for selling counterfeit goods online.

There are a number of solutions and technologies to prevent or reduce counterfeiting. Almost every firm or owner is motivated to patent their products so that they can sue the counterfeiters in court. Hence, the owners keep a patent and product watch from time to time. However, the owners may still be unaware of counterfeit if the product watch not performed carefully or ignored sometime. There are different technologies which assist in reducing counterfeiting. Anti-counterfeiting based on an electronic device may be added to a product, which must be protected against counterfeiting. For example: RFID tag. Such an electronic device can be used to track and trace the object. US patent publication U.S. Pat. No. 9,311,589 discloses an anti-counterfeiting RFID tag structure including a body and a RFID device disposed on a body of a bottle container. The RFID device includes a RFID chip circuit and an antenna structure. The anti-counterfeiting RFID tag structure is disposed fully between the cap and the opening of the bottle container whenever the bottle container is sealed. A user reads anti-counterfeiting ID code and product curriculum vitae data stored in the RFID device, using a stationary or handheld RFID reader, so as to effectuate identification and anti-counterfeiting. Chinese patent publication CN 104732172 discloses a pen with RFID anti-counterfeit detection. The pen includes a processor (1), a GPRS module (2), a display screen (3), an RFID antenna (4), a battery (5) and a pen body (6). The GPRS module and the RFID antenna are arranged on the pen, so that a detection device is portable, and the detection device can be used for detecting at any time simultaneously.

Some conventional arts employ NFC (Near Field Communication) enabled mobile device system to determine authenticity of products. For example, US patent publication US20150106113A1 discloses a counterfeit pharmaceutical product identification system and method for determining authenticity of pharmaceutical products using NFC (Near Field Communication) enabled mobile device. The system includes a unique secure code, invisible to human eyes, is embedded inside the packaging of the pharmaceutical products. An authentication server stores a database of pharmaceutical products and the unique secure codes associated with each of the pharmaceutical products. At least one mobile device, connected to the server, is configured to read unique secure code embedded inside the packaging of the pharmaceutical product, by bringing the mobile device in close proximity to the packaging. The mobile device authenticates the pharmaceutical product by communicating with the authentication server and comparing the unique secure code attached to the pharmaceutical product with the secure code saved in the database whereby identifying the genuine pharmaceutical product instantly.

The products undergo different phases and move to different locations from manufacturing until distribution. There can be chances of counterfeiting at any step of manufacturing until distribution. Determining such a location of the counterfeit may provide an evidence of counterfeit to be shown to police or court to catch counterfeiters.

Therefore, there exists a need for developing an anti-counterfeiting system which can provide precise location information of the counterfeiting of the goods or commodities.

### SUMMARY OF THE INVENTION

The present invention has been made in the view of the above problems, and the present invention discloses an anti-counterfeiting chip in accordance with an illustrative embodiment. The chip includes a NFC (near field communication) module; a Jeptag module; a GPS positioning module; a local information generating module; a memory module ROM/RAM; and a cloud connectivity module. The chip is configured to store attributes of a commodity being tracked for counterfeit of a commodity. The chip is configured to track location of the counterfeit.

In another illustrative embodiment, the present invention discloses an anti-counterfeiting system. The system includes an anti-counterfeiting chip, further including a NFC (near field communication) module; a Jeptag module; a GPS positioning module; a local information generating module; a memory module ROM/RAM: and a cloud connectivity module. The chip is configured to store attributes of a commodity being tracked for counterfeit of a commodity. The chip is configured to track location of the counterfeit. The system also includes a reader for reading the chip, a GPS satellite, and a cloud server having memory storage.

In yet another illustrative embodiment, the present invention discloses a method for tracking counterfeit of a commodity from manufacturing until distribution. The method includes a number of steps, sequence of which disclosed herein may be exemplary. The method includes encoding NFC based anti-counterfeiting chip. The method includes mounting the NFC based chip. Jeptag chip, OPS receiver on the commodities. The reader scans the chips. The method further includes uploading the commodity information on the chips and a cloud server. The method automatically detects location of the commodity through GPS, followed by uploading the detected location of the commodity on the chips and the cloud. Finally, the method records and tracks the location of counterfeit of the commodity.

### BRIEF DESCRIPTION OF DRAWINGS

Other objects, features, and advantages of the invention will be apparent from the following description when read with reference to the accompanying drawings. In the drawings, wherein like reference numerals denote corresponding parts throughout the several views:

FIG. 1 illustrates different modules of an anti-counterfeiting chip, in accordance with an illustrative embodiment of a present invention;

FIG. 2 illustrates different modules of an anti-counterfeiting system, in accordance with another illustrative embodiment of the present invention;

FIG. 3 shows a schematic of a flowchart depicting a method for tracking counterfeit of products from manufacturing until distribution thereof, in accordance with yet another illustrative embodiment of the present invention; and

FIGS. 4A-4F illustrate results of alpha testing of the anti-counterfeiting system and the method thereof, in accordance with the above embodiments of the present invention.

### DETAILED DESCRIPTION OF THE PREFERRED EMBODIMENTS

Reference will now be made in detail to the preferred embodiments of the present invention, examples of which are illustrated in the accompanying drawings.

In the following detailed description, numerous specific details are set forth in order to provide a thorough understanding of the invention. However, it will be understood by those or ordinary skill in the art that the invention may be practiced without these specific details. In other instances, well known methods, procedures and/or components have not been described in detail so as not to obscure the invention.

The invention will be more clearly understood from the following description of the methods thereof, given by way of example only with reference to the accompanying drawings. In the descriptions that follow, like numerals represent like elements in all figures. For example, where the numeral (2) is used to refer to a particular element in one figure, the numeral (2) appearing in any other figure refers to the same element.

In order to track exact location of counterfeiting of the commodities, and to record evidence thereof to show thereof to police or court, the present invention relates to an anti-counterfeiting system and a method thereof. In some embodiments, the anti-counterfeiting system involves an anti-counterfeiting chip to track location of the counterfeiting.

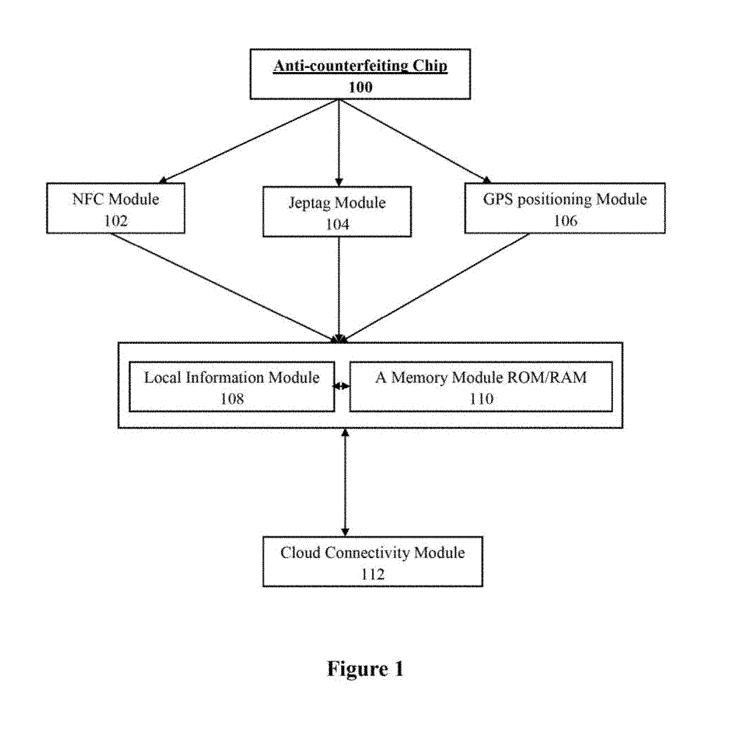

As shown in FIG. 1, the anti-counterfeiting chip 100 includes a number of modules to perform functionality thereof to track down location of counterfeiting. The chip 100 includes a NFC (near field communicator) module 102 to verify authenticity of the commodity. In some embodiments, the module 102 may be encoded such that NFC electronic tag may be tagged on the commodity. The module 102 may also include a set of instructions stored in a reader. Examples of the reader may include such as but are not limited to mobile phone, tablet, Smartphone such as iPhone6, and so on, scanner, and other handheld terminals. As the reader is in close proximity to the commodity, the NFC tag communicate with each other. As the unique ID code of the commodity matches with that of the reader, the commodity's authentication is verified.

The chip 100 includes a Jeptag module 104 wherein the module 104 further includes a Jeptag electronic tag functionality code installed in the chip 100. The Jeptag is one of the anti-counterfeit solutions which can be uploaded on the reader in a similar way that of the NFC module. Various attributes of the commodities that can be uploaded on the reader such as including but are not limited to picture, description such as date of manufacturing, color of the commodity, features thereof, and so on. Other attributes that can be uploaded on the reader may be barcode information.

The chip 100 may also include a GPS positioning module 106. The module 106 is configured to receive satellite information from GPS satellites. In some embodiments, the module 106 receives location information such as longitude, latitude, altitude, time and satellite information. Such a module 106 having a set of instructions with respect to GPS can be installed in the chip 100.

In some embodiments, the chip 100 includes a local information module 108. The module 108 is configured to download all the commodity details as described hereinabove. Thereafter, the module 108 combines all the downloaded data with local data to generate label information of the commodity.

In some embodiments, the chip 100 includes a memory module RAM/ROM 110. The module 110 is configured to read, write, upload, and download commodity information therein. Such memory can have storage capacity of at least 56K bit and is expandable. In some embodiments, both the modules 108 and 110 interact with all the three modules 102, 104, and 106.

The cloud connectivity module 112 may interact with the other modules 102, 104, 106, 108, and 110 to send the received information about the commodity to a cloud server. Details of the cloud server are discussed hereinafter.

In some embodiments, the chip 100 includes other modules such as a wireless Internet access module, a digital encryption and decryption module, a microprocessor, an upload control module, and so on. The wireless internet access module may include wireless connectivity supported through Wi-Fi and may include different communication protocols such as GPRS/3G, 4G, and so on. The modules 102, 104, 106, 108 can communicate with a cloud server in a cloud connectivity module 112 via the wireless internet access module.

The digital encryption and decryption module may include a CPU card which is configured to store the encryption and decryption program, the private key and the digital certificate of the chip 100. The private key may be uniquely stored on the CPU Card therein. Such an encryption and decryption does not allow altering of the codes and the information of the commodity stored in the chip.

The microprocessor in the chip 100 may be configured to ensure coordination of all the modules 102, 104, 106, 108, 110, and 112. In some embodiments, the upload control module is configured to upload the information on the chip 100 as the information is received therein. For example, as the commodity moves from location 1 to location 2, the commodity at location may have new geo-based attributes received from the GPS satellite. Hence, such new information may be immediately uploaded on the chip 100.

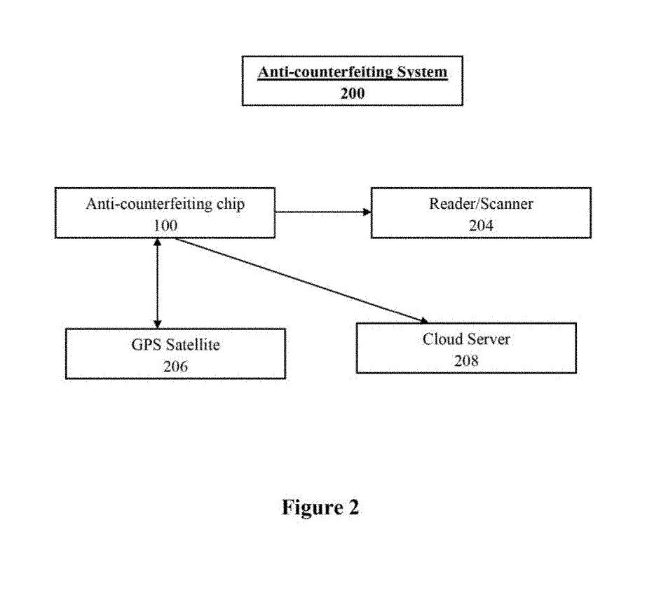

As shown in FIG. 2, the present invention discloses an anti-counterfeiting system 200 in accordance with another illustrative embodiment. The system 200 may essentially include a number of components including such as but are not limited to the anti-counterfeiting chip 100; a reader/scanner 204; GPS satellite 206, and a cloud server 208. The reader 204 may include such as but are not limited to mobile phone, tablet, Smartphone such as iPhone6, and so on, scanner, and other handheld terminals. The reader 204 may be configured to scan the chip 100, thereby retrieved all the saved information from the chip 100. The saved information may define all the information of the commodity such as information contained in the modules 102, 104, and 106.

The GPS satellite 206 is configured to transmit geo-based attributes information to the chip 100 and the cloud server 208. The satellite 206 may record geo-based attributes information as the commodity moves from location of manufacturing to distribution. For Instance, the commodity ready to go for manufacturing at original location of owner, the location thereof may be captured through the satellite 206 and saved onto the chip 100 and the cloud server 208. Further, as the commodity moves to a next location of the counterfeit, such location may be recorded accordingly. In case, a counterfeiter tries to replace the original commodity by fake products, the location of the original commodity can immediately be traced. In another case, a counterfeiter tries to steal the original commodities and sell them; location of the original commodity can immediately be traced out. In another case, consumer can check authenticity of the original commodity by downloading set of instructions on their Smartphone and bringing the Smartphone in proximity with the commodity. If the unique ID of the commodity matches with that of the code on the Smartphone, then the commodity is original, otherwise fake.

In some embodiments, the cloud server 208 is already known in the art and may include memory storage to store information about the commodity.

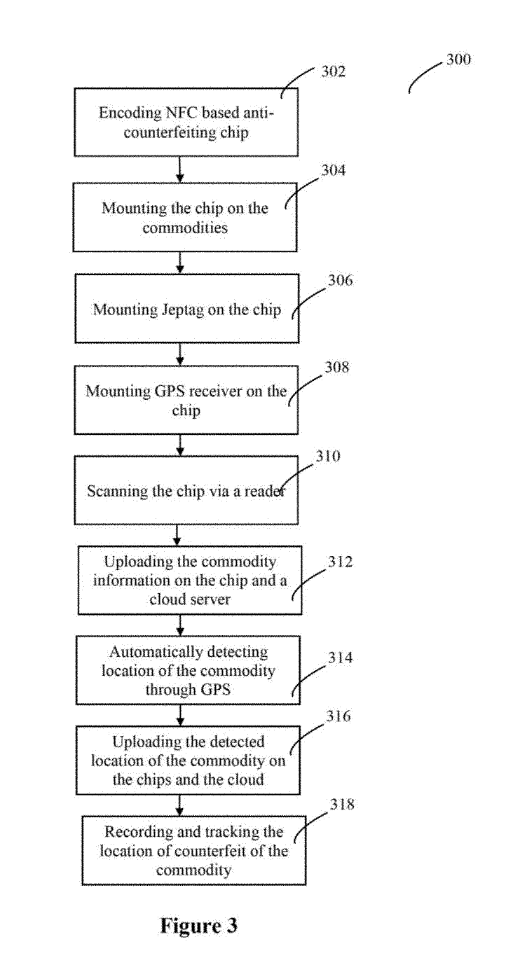

Further as shown in FIG. 3, the present invention discloses a method 300 for tracking location of the counterfeit of the commodity. The method 300 includes a number of steps, sequence of which described hereinafter is exemplary to understand the invention for persons skilled in the art. The method 300 includes encoding NFC based anti-counterfeiting chip 100 at step 302, and mounting the chip 100 on the commodity at step 304. The method 300 further includes encoding and mounting the Jeptag on the chip 100 of the commodity at step 306. Thereafter, the GPS receiver can be encoded within the chip 100 at step 308. The chip 100 undergoes scanning via the reader/scanner 204. In an embodiment, the information of the commodity at location of the manufacturing thereof (origin of the commodity) may be on the chip 100 and the cloud server 208 at step 312. In another embodiment, as the commodity is transported from one location to another, all of the information of the commodity may be uploaded on the chip 100 and the cloud server 208 at step 312. The information may be defined as a picture, features, and date of manufacturing, expiry, and other physical features of the commodity. The method 300 may further automatically detect location (geo-based attributes) of the commodity through GPS at step 314. Thereafter, the geo-based attributes may be uploaded and saved on the chip 100 and the cloud server 208 at step 316. Finally, the method 300 involves recording and tracking the location of the counterfeit of the commodity at step 318.

In another embodiment of the present invention, the system can work without internet connection also by downloading the relevant data once the desired input is provided by the user. The item or commodity can thus be tracked from the manufactory till it reaches the customer in the offline mode also. The relevant software associated with GPS tracker saves both the location and thus keeps track of the shipment item in the offline mode also.

In some embodiments, the commodities may be any commodity that is manufactured and distributed for sale. In some embodiments, the commodities may be ready-made and distributed for sale. In some embodiments, the commodities may be any commodity which may be counterfeit. In some embodiments, the commodities may include such as but are not limited to clothing, confectionary items, bakery items, automobile parts, dairy products, and so on.

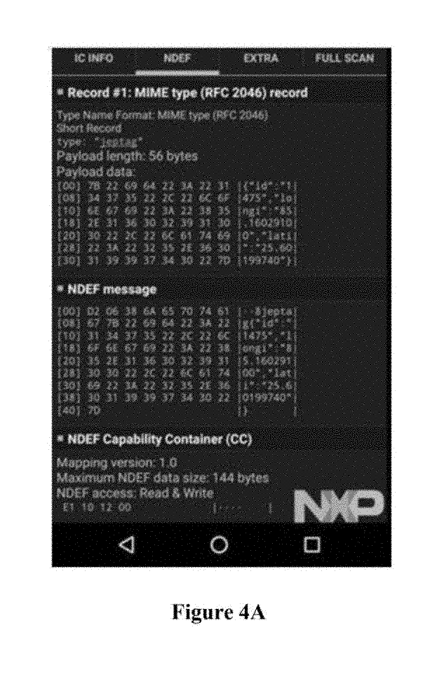

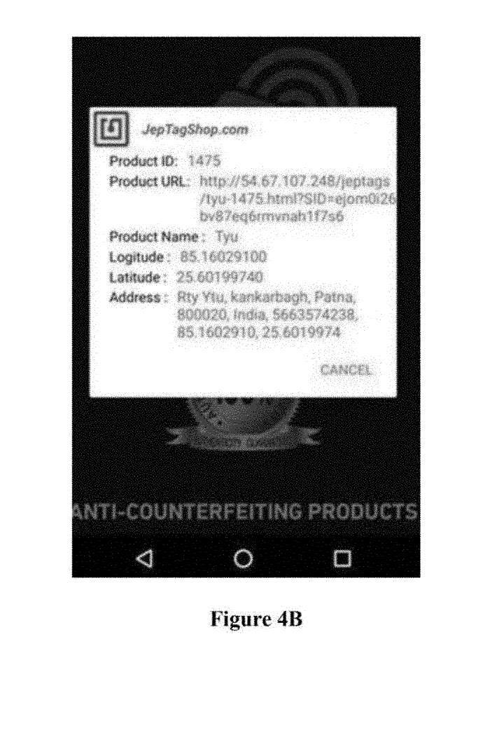

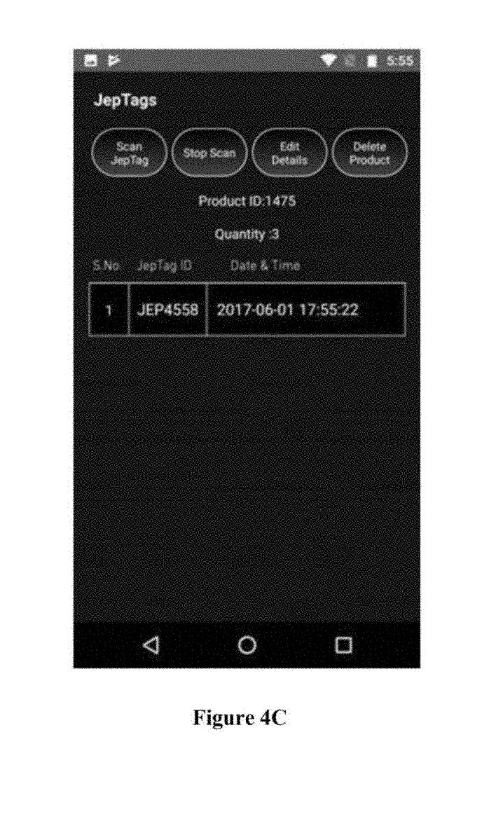

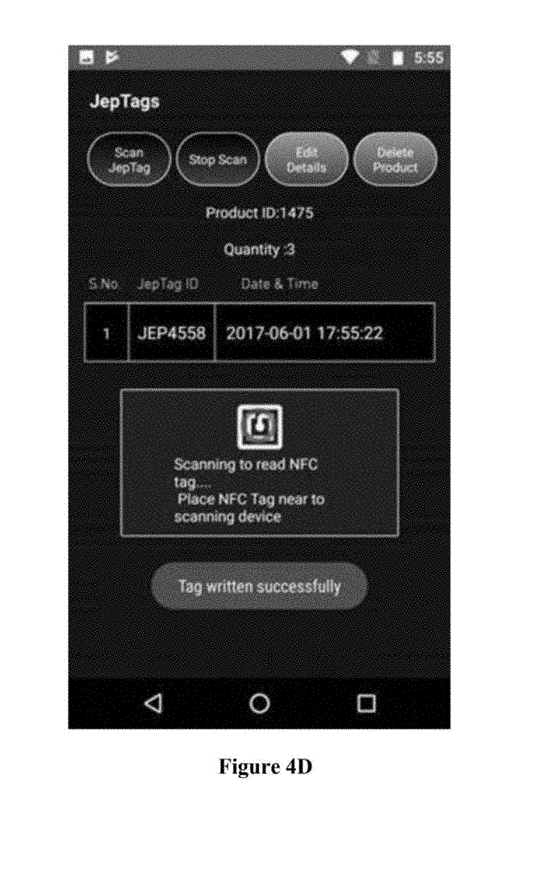

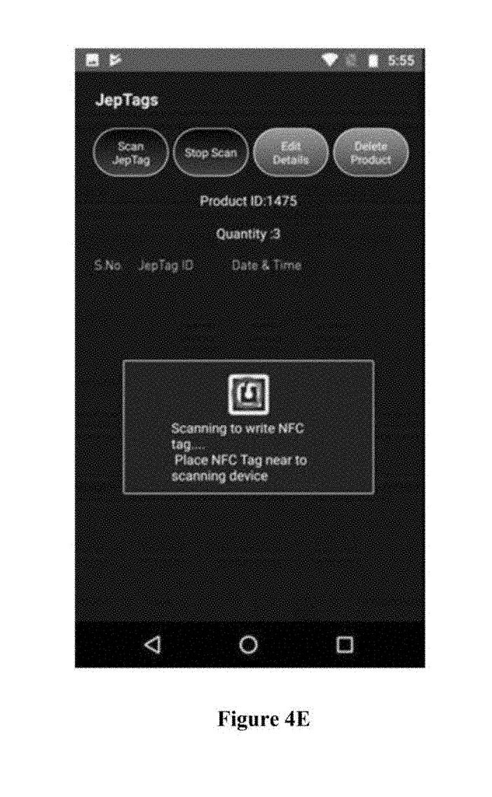

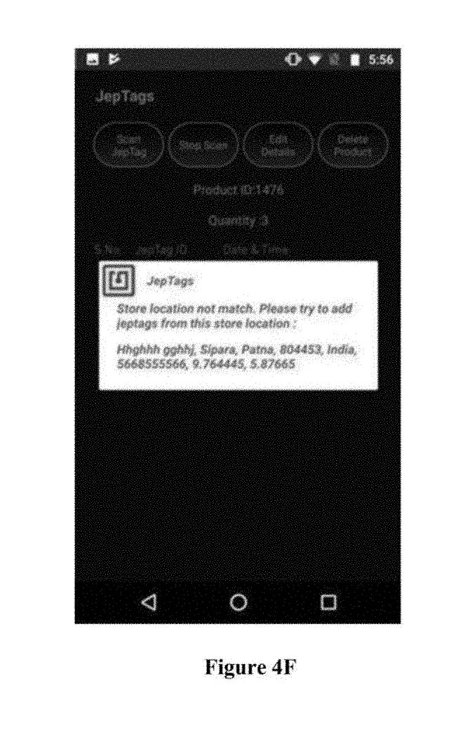

Further, FIGS. 4A-4F illustrate results of alpha testing of the system 200 and the method 300 thereof. The alpha testing may be performed to identify all possible issues/bugs before releasing a product to everyday users or public. As shown in FIG. 4A, the testing uploads (read and write) all the raw information such as data size of all the information of the commodity. FIG. 4B illustrates all the information uploaded by the Jeptag module, for example, Product ID, URL (an online link to view the product), Product Name, Geographical attributes received from the GPS satellite such as longitude, latitude, and address of location of the commodity.

Further, FIG. 4C illustrates the testing scanning the Jeptag module to retrieve the saved information of the commodity therein. Date and Time of scanning the Jeptag module is uploaded.

FIGS. 4D-4E illustrate the testing performing reading and writing NFC tag respectively, followed by bringing the reader in proximity to the NFC tag. FIG. 4F shows that the store location of the commodity does not match, indication counterfeiting of the commodity. The system further provides complete address of the location of the commodity. Such a testing was performed on at least 50 commodities in both the situations-if the commodity is counterfeit, and if the commodity is not counterfeit. The system and the method thereof underwent alpha testing successfully.

While the preferred embodiment of the present invention and its advantages has been disclosed in the above Detailed Description, the invention is not limited there to but only by the scope of the appended claim.

As will be readily apparent to those skilled in the art, the present invention may easily be produced in other specific forms without departing from its essential characteristics. The present embodiments are, therefore, to be considered as merely illustrative and not restrictive, the scope of the invention being indicated by the claims rather than the foregoing description, and all changes which come within therefore intended to be embraced therein.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. An Anti-Counterfeiting system comprising:
An upload control module configured to upload the real time information on the chip;
A microprocessor configured to ensure coordination between all other modules.

26. The system of claim 25, wherein an upload control module is configured to immediately upload the information on chip as the commodity to be tracked moves from one location to another having new geo-based attributes received from the GPS satellite.

27. The system of claim 26, wherein the GPS satellite records geo-based attributes information as the commodity moves from location of manufacturing to distribution.

28. A system of the anti-counterfeiting chip to track location of counterfeiting of the commodity during manufacturing until distribution wherein;
the system automatically detects all the locations of the commodity from manufacturing until distribution;
The system uploads the detected locations of the commodity from manufacturing until distribution on the chips and the cloud.
